(19) United States
(12) Patent Application Publication
(10) Pub. No.: US 2004/0039932 A1
(43) Pub. Date: Feb. 26, 2004

(54) Apparatus, system and method for securing digital documents in a digital appliance

(76) Inventors: Gidon Elazar, Tsur-Igal (IL); Dan Harkabi, Lachish (IL); Nehemiah Weingarten, Ramat Gan (IL)

Correspondence Address: WILSON SONSINI GOODRICH & ROSATI, 650 PAGE MILL ROAD, PALO ALTO, CA, 943041050

(21) Appl. No.: 10/227,155

(22) Filed: Aug. 23, 2002

(51) Int. Cl. H04L 9/00

(52) U.S. Cl. 713/200; 705/59

(57) ABSTRACT

Various embodiments include an apparatus and a method to secure protected digital document content from tampering by their user, such as unauthenticated use or use violating a policy of the digital document. The digital document file can be transferred from a network node such as a web site server to a digital appliance, such as a computer, in encrypted form. The digital document file can be resident already on a device, and/or be transferred into a device that is connected to the digital appliance. The device (hereafter a DRM device) can internally store the digital document or part of the document. The DRM device may decrypt the digital document when requested to do so. The device may further format the content for usage, for example, convert text into its graphic bitmap representation. Device formatting can include sending plain text data to the digital appliance. The device may further process degradation to the resulted file, for example, reduce the resolution of the graphic representation. The digital appliance uploads the result of the processing or sections of the result of the processing for user access via the digital appliance.

### FIELD OF THE INVENTION

This invention generally relates to digital rights management. More particularly this invention relates to methods of securing digital documents to be used in a digital appliance such as a personal computer.

### BACKGROUND OF THE INVENTION

The Internet worldwide network enables many digital appliances to interconnect and exchange information. A particular use of the Internet is to distribute digital files, specifically digital content such as digital books or music files, to the connected appliances.

The proliferation and distribution of digital music files is substantial. Various devices, programs and methods to listen to digital music are available, and an increasing number of music title exists in digital form. Unfortunately there exists a substantial amount of illegal copies of digital music files, such that the rights of the owner of the music cannot be exercised with respect to the illegal copies.

Digital books are substantially less popular and common than music. One of the reasons for the difference between the proliferation of music in digital form and books in digital form is the caution felt by book content rights owners against potential copyright infringement, a lesson learned from the experience of the music industry. Concerns about losing control over the management of rights prevents the usage of the Internet as a powerful digital content distribution infrastructure.

Digital rights management (DRM) systems are developed to challenge the above difficulties. Part of the function of a typical DRM system is to define the form of “rights-protected files”—methods that enable the use of digital files under limitations defined by the owner of the rights to the content. These systems typically involve cryptographic methods for the secure distribution of the content between a content repository or server and a digital appliance. Such methods typically require the appliance to include an implementation of cryptographic algorithms and hold cryptographic keys in order to gain access to the content. The access to the content is performed through a program that is DRM sensitive and is hereafter called—an electronic book reader.

Examples of electronic book reading software are the Adobe Acrobat, Adobe eBook Reader (http://www.adobe.com) and the Microsoft eBook Reader (http://www.microsoft.com/reader). Such software implements some form of DRM that is engaged when the users attempts to open and view a digital document. One of the operations performed by such electronic book readers is the process of decrypting the document using cryptographic methods and cryptographic keys. In order to do so, the reader program must have access to the cryptographic methods and keys; therefore the cryptographic methods and keys must reside within the access of the reader program. Typically the cryptographic methods, the keys, or both reside within the reader program, on the document itself, or somewhere within the appliance storage.

A digital appliance such as a computer is typically an open platform enabling computer programmers to develop programs. In some cases, software programs are developed for the purpose of hacking and locating the cryptographic keys and algorithms of a DRM system (hereafter referred to as hacking programs), in order to circumvent the DRM and gain illegal access to the content. This process is generally called an “attack” and if it succeeds it is commonly referred to as to “crack” the DRM system. A computer program that performs this function is referred hereafter as a hacking program.

Examples for such successful attacks are well known in the art. In late 2001, a programmer was able to crack the Microsoft eBook reader and locate the cryptographic methods and keys, producing a program that inputs an encrypted eBook file and outputs an illegal electronic book that is not protected (http://www.technologyreview.com/articles/innovation1101.asp). A similar cracking event of the Adobe system took place earlier that year (http://www.wired.com/news/politics/0,1283,45298,00.html).

Other forms of attacks include using programming tools. For example, software debuggers track and trap the electronic book information after the electronic book reader has decrypted it, retrieving the “protected” information. Such information includes the book text, images and attributes such as fonts, text color, and image locations, etc., which instruct the electronic book reader on how it should reconstruct the book for presentation to the user. A hacking program that cracks the reader and releases this information from the DRM system enables the construction of illegal copies of the original electronic book.

As a countermeasure, DRM systems have used more sophisticated cryptographic schemes and code obfuscation techniques. Other methods include adding tamper resistant hardware to store the cryptographic keys. Examples of such methods are cryptographic tokens such as iToken of Rainbow Technologies Inc. (http://www.rainbow.com/ikey/index.html) and using a smart card to store cryptographic keys and optionally cryptographic algorithms. Such solutions either reveal the cryptographic key to the digital appliance in the process of decrypting the information, or internally perform the cryptographic functions but reveal the end result in a raw form that can be hacked. In practice these methods were proven to slow, but not halt, an adversary. Given enough time and effort a computer program that “cracks” the DRM system may be written. It can be appreciated by those skilled in the art that such successful attacks may occur to such program readers that execute in an open environment that enables programmers to develop software programs. Similarly, cryptographic co-processors leave the content vulnerable after decryption.

Several ongoing initiatives focus on securing the personal computer itself.

As result, a major effort is being taken by the industry, led by companies such as Microsoft to protect some part of a personal computer by transforming that part into a closed system. (http://www.microsoft.com/presspass/features/2002/ju102/0724palladiumwp. asp). This initiative may produce a personal computer that is less sensitive to viruses, can be identified by service providers over the network, and can be used to build a DRM system. Microsoft's Palladium defines how to make the operating system of the personal computer secure. Once the operating system is secure, the PC is considered trusted and it can be used for purposes such as DRM. The Wave Embassy verification system secures an appliance. Unfortunately these initiatives will be realized only in future digital appliances, which must incorporate technology specific to Palladium and Wave Embassy for securing the personal computer itself. There is clearly an unmet need for a system, method and device for securing digital documents in a digital appliance.

### SUMMARY OF THE INVENTION

The above-mentioned disadvantages and problems are addressed by the present invention, which will be understood by reading the following specification. To protect the cryptographic keys and cryptographic methods from being located within a digital appliance, according to the present invention the keys and methods are stored and executed in a dedicated DRM device that has processing capability distinct from the digital appliance, and does not provide an open environment for at least some security functions of the DRM device for programmers to develop programs. In some embodiments, another party may develop additional functions.

According to some embodiments, a digital document file or a section of the digital document that is protected is downloaded from an Internet server to the DRM device through a digital appliance. According to other embodiments, the digital document is already resident in the DRM device. Once the document is internal to the device, several processes may take place.

In some embodiments, if the document is in an encrypted form it is processed through a decryptor to produce a decrypted form. A decrypted digital document can be processed by a formatter internal to the DRM device to produce a formatted form of the digital document or the section of the digital document, such as, but not limited to, a bitmap image of a page of the document. Other examples of formatting include passing plain text to the digital appliance.

The DRM device can further process policies such as allowing or disallowing a formatted form of the document to be transferred to the digital appliance, for example in order to be presented to the user. The policy may be based on rights of use, time, number of usage events and so on. Some embodiments involve end use of digital documents. Other embodiments involve end use of music data and/or video data.

### BRIEF DESCRIPTION OF THE DRAWINGS

The foregoing and other objects, aspects and advantages will be better understood from the following detailed description of an embodiment of the invention with reference to the drawings, wherein:

FIG. 1 is a schematic block diagram of an embodiment of the DRM device;

FIG. 2 is a schematic block diagram of an exemplary system;

FIG. 3 is a flowchart of an exemplary method for delivering a digital document file using the system of FIG. 2;

FIG. 4 is a flowchart of an exemplary method for using the digital document file of FIG. 3;

FIG. 5 is a schematic block diagram of another exemplary system; and

FIG. 6 is a flowchart of another exemplary method for using the digital document file of FIG. 3.

### DETAILED DESCRIPTION OF THE INVENTION

In the following detailed description of exemplary embodiments of the invention, reference is made to the drawings that illustrate specific exemplary embodiments in which the invention may be practiced. Those skilled in the art will appreciate that other embodiments may be utilized without departing from the spirit of the present invention, therefore the following detailed description of the invention should not be taken in a limiting sense. The scope of the invention is defined only by the appended claims.

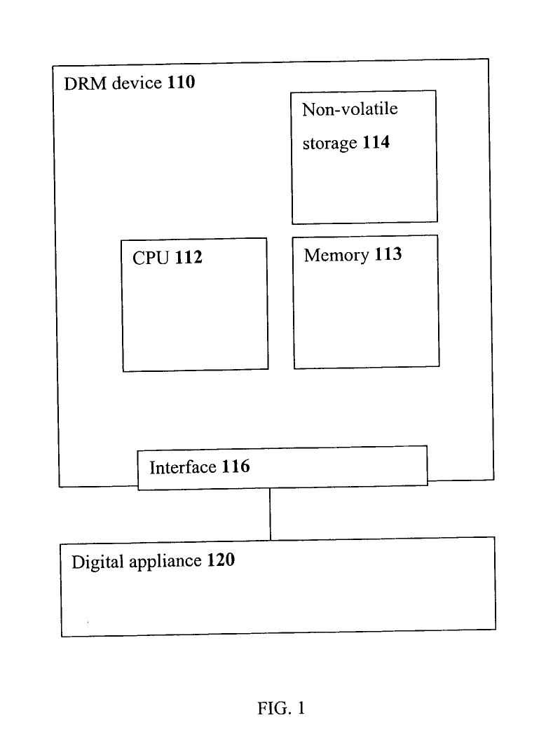

FIG. 1 is a diagram of an exemplary embodiment of the DRM device hardware 110, which includes a central processing unit (CPU) 112, an optional system memory 113, non-volatile storage 114, and an interface 116 to connect the device 110 to a digital appliance 120. There may be only one or a plurality of central processing units 112, as there may optionally be only one or a plurality of system memory 113 or non-volatile storage 114. There may be only one or a plurality of interfaces 116; the invention is not so limited. The non-volatile storage 114 may be included in the CPU 112 or be discrete from the CPU 112; generally, components or subcomponents of the DRM device hardware 110 may be combined with other components or subcomponents of the DRM device for higher integration and perhaps lower cost.

The CPU 112 may be a general purpose CPU or a CPU with dedicated functions. Furthermore the CPU 112 may include internal memory, and internal non-volatile storage which in the description of the present invention may serve a similar purpose of the system memory 113, and non-volatile storage 14 respectively. The CPU 112, the non-volatile storage 114, and/or other components may be implemented as a tamper resistant hardware, or sections of the CPU 112, the non-volatile storage 114, and/or other components may be tamper resistant; the invention is not so limited.

The non-volatile storage 114 may be any of several types of storage including semiconductor based media such as read only memory (ROM), electronic erasable programmable read only memory (EEPROM), flash memory or battery backed up random access memory (RAM); or magnetic media storage such as hard disk drive or floppy disk, or the like.

The interface 116 can connect the DRM device 110 with a digital appliance 120 in both physical and communication aspects. The physical aspect can be, for example directly, through one or more cables, and/or wireless. The communication aspect of the interface 116 allows data exchange between the DRM device and the digital appliance. The interface 116 may be any of several types of interfaces, for example PCI, ISA, Universal Serial Bus (USB), FireWire, IDE, SCSI, RS-232 or other serial interface, parallel interface, Compact Flash (CF) interface, Sony Memory Stick interface, Multimedia Card (MMC), secure digital (SD), Bluetooth, Infiniband, and/or any other type of interface that may be used to connect a DRM device with a digital appliance.

The digital appliance 120 is used by an end user for some end use of one or more digital documents. A digital document is data which has an end use of being read by an end user, and at some point prior to end use is stored and/or represented in numerical form. The digital document can have various purposes, for example a corporate purpose such as a sales presentation, a legal contract, a finance spreadsheet, or the like; or an academic purpose, such as an academic book, a published paper, a student class pack reader, or the like; or a commercial purpose, for example a newspaper, a periodical journal, a comics journal, or the like; or the like various purposes that a digital document may have. The digital appliance 120 may be one of several digital appliances such as a personal computer, tablet computers, personal digital assistant (PDA) or other types of hand held devices, cell phones, programmable consumer electronics and the like. End use includes use of the DRM device by an end user to access digital document content. Some examples of tasks which can be performed in connection with accessing the document content include viewing the content of the document or a section of the document, modifying the document, searching the document for a text string, copying parts or all of the document, selecting text within the document to perform an operation on that text, add overlay comments on top of existing content, respond to assignments by adding content to the document or adding content to a matching but separate document, listening to a voice version of the document, printing sections or all of the document, sharing the document with other end users, transferring all or part of the document to other end users, transferring the rights to use the document to other end users, aggregation of several documents or sections of several documents into one or more new documents and other like operations that a user may apply to a digital document. The invention is not so limited.

The non-volatile storage 114 contains instructions which may be executed by the CPU 112. The non-volatile storage 114 further may contain: an optional unique device serial number, a method of authentication such as a unique pair of public and private cryptographic keys and a signed authenticity certificate. The instructions stored in the non volatile storage 114 allow the digital appliance 120 to access a portion of the non volatile storage 114 through the interface 116, but prevent access to another portion of the non volatile storage 114, including a portion that stores the private cryptographic key and a portion that stores instructions that execute in a closed environment without enabling user access. The non-volatile storage may also store a plurality of methods for authentication; the invention is not so limited.

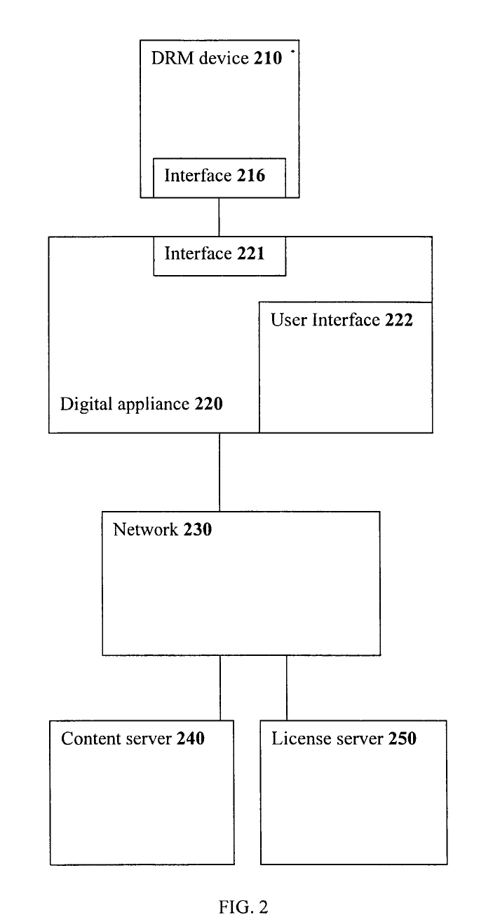

FIG. 2 is a diagram of an exemplary embodiment of the system which includes a DRM device 210 with an interface 216, a digital appliance 220 with an interface 221 which matches the interface 216 of the DRM device 210, a user interface component 222 on which a processed document may be presented (for example as a visual image, synthesized audio or other form) to the user, the network 230, a content server 240 which is a computer that can transfer digital documents over the network and a license server 250 which is a computer that may transfer authentication and/or decryption and/or policy and/or formatting information over the network. According to one embodiment that information is embedded in one or more files. According to one embodiment the servers are optionally interconnected. The system may include a plurality of DRM devices 210, digital appliances 220, content servers 240 and license servers 250, the invention is not so limited. It may be appreciated by those skilled in the art that the content server 240 and the license server 250 may be implemented as separate or unite hardware and/or software components.

The interface 221 connects the digital appliance 220 with a DRM device 210. The interface 221 may be any of several types that may be used to connect a device with a digital appliance. The interface 221 of the digital appliance matches the type of interface 216 of the DRM device in a form that enables information to pass between the DRM device 210 and the digital appliance 220.

The content server 240 is a computer that can be accessed through a network 230 such as the Internet network. The content server 240 can respond to requests to download content such as digital electronic documents. Examples of content servers can be Amazon.com or another on-line bookseller web site that enables downloading of electronic books to a personal computer, a university web site that enables downloading of electronic versions of articles to a researcher's personal computer, and a corporate web site that enables employees to download corporate documents to their personal computers. A license server 250 is a computer that can be accessed through a network 230 such as the Internet network. A license server 250 can respond to requests to download information such as authentication and/or decryption and/or policy and/or formatting information. This data may include: definition of policies to be used by the DRM device policies, definition of formatting to be used by the DRM device formatters, definition of decryption to be used by the DRM device decryptors, definition of authentication to be used by the DRM device authenticators, parts of the text of the electronic document or parts of the electronic document, information regarding the user, information regarding the rights of the user to one or more end uses (the user may have access to all possible end uses or less than all possible end uses) of the document or part of the document, information regarding the vendor/owner/operator of the system, information regarding the specific DRM device, and other information. The information may be utilized by the DRM device or the digital appliance while the user makes use of the content or in preparation to enable the user to make use of the content or any additional information. According to one embodiment the content server 240 and the license server 250 are implemented as separate entities that interconnect through a network and do not directly interconnect. According to another embodiment the servers directly interconnect. According to another embodiment the content server 240 and the license server 250 are implemented as a single entity. The invention is not so limited.

An authenticator implemented in a DRM device participates in the process of authenticating the DRM device to a remote server over a network. An authenticator may implement one of several methods of authentication including sending a device ID number to the remote server. Another authenticator uses an encryption secret key known only to the device and the server, and bases the authentication on challenging the device in order to verify that it has possession of the secret key. In an exemplary embodiment of such an authentication process the server sends an encrypted message to the device, and the authenticator at least decrypts the message and returns it to the server. In some embodiments, the same key can be used in a variety of methods to authenticate, for example, by signing a plaintext message and/or decrypting an encrypted message. In some embodiments, the authenticator responds to challenges by performing a series of operations such as decrypt a message, process the result, encrypt the result, and return it to the server for verification. For this authentication process to occur, the secret key may be stored in the device prior to the authentication process. The stored key can be a single key stored equally on all devices or a dedicated key unique to each device. In the latter case the server should know in advance which key is stored within which device. Another method to authenticate uses a public and private key and a digital certificate. In such an embodiment, the authenticator has access to a private key and a matching public key stored in the device The private key must be kept secret, but the public key may be made public. The server may then challenge the authenticator with a message encrypted with the device public key to ensure it has access to the matching private key. In some embodiments, the authenticator signs a message but does not necessarily encrypt the message. Optionally the server can receive from the device a digital certificate, which contains device identification information such as the device serial number or device ID and/or the public key of the device and/or additional information relating to the device, the server, the organization operating the system or any other information. The device identification information is digitally signed by a trusted authority, such as the vendor of the device, owner of the server, the organization operating the system and/or another trusted authority to form a digital certificate for that device. Some embodiments of the authenticator can authenticate the DRM device and/or a user of the DRM device.

A decryptor in the device participates in the process of transforming encrypted documents or sections of documents into a decrypted form. A decryptor may implement one or more of several methods: symmetric algorithms such as DES, 3DES, AES, and IDEA; and/or asymmetric algorithms such as RSA, Diffie-Hellman, elliptic curve; and/or others. A decryptor may implement one or a plurality of decryption methods. A decryptor may include hashing algorithms such as DSA, MD2, MD4, MD5, HMAC and/or SHA1 and/or others to retrieve a signature and check origin and integrity of the data received. The decryption key or plurality of decryption keys for such operations may originate in one or a plurality of sources. For example, decryption key data can be stored in the non-volatile storage of the DRM device, received from the digital appliance, and/or received from a network server, such as through the digital appliance. Some embodiments receive digital document content which is at least partly decrypted. In such embodiments, obviously the decryptor may or may not process the already decrypted portion. The decryptor can at least partly decrypt—for example, fully decrypt part of a document, and/or perform one or more decryption steps, which can be the complete decryption process or a subset of the complete decryption process, for a whole or part of the document. In some embodiments, the document can be received at least partly as plaintext—in other words, received as at least partly unencrypted.

A policy in the device participates in the process of verifying the eligibility of end use of a document or a section of a document, allowing or disallowing operations such as decrypting, formatting, searching, and/or transmitting an output to the digital appliance. The verification may check one or several eligibility options, including the right to use the document, the right to use the document up to a certain date, the right to use the document between certain dates, the right to use the document after a certain date, the right to use the document for a certain accumulated usage time, the right to use the document for a certain number of times, the right to transfer the document, the right to modify the document, the right to add overlay information on the document, the right to save the document into the device and/or another location, the right to save the overlay information into the device and/or another location, the right to copy the document, the right to copy portions of the document, the right to copy specific sections of the document, and other rights related to an end user in connection with an end use of the document. These might be checked by the policy to produce a result that might be one or more possible actions such as allowing the output to be transmitted to the digital appliance, disallowing the output from being transmitted to the digital appliance, erasing the document or part of the document, and/or allowing or disallowing operations such as search, cut, paste, copy, edit, save, and other operations that a user may perform while in an end use of the document.

A formatter defines a process step in formatting a document into a presentable form. A formatter may do one or more formatting operations including: selecting the section of the document to be presented; conversion of the text, graphics and images to a single or set of digital images in one of many formats such as a bitmap image (BMP) or like form or compressed image such as JPEG, TIFF, GIF; or any other like form; setting spaces between characters and letters according to the required display form; searching the text for a particular text string; generating the layout of the document; drawing the text characters in the appropriate font and font size; and other operations performed in the preparation and conversion of a document into a presentable form. Some embodiments of a formatter degrade at least part of the document. Some embodiments arrange a presentation of the digital document content by presenting visual and/or audio information, such as presenting a voice version of the document.

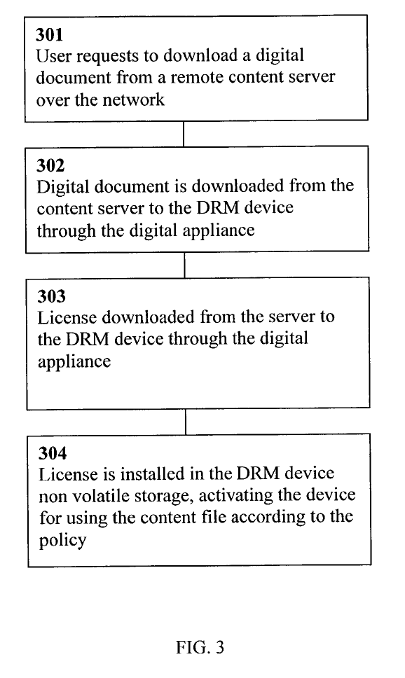

FIG. 3 is a flow chart describing an exemplary sequence of operations carried out when a user downloads content from a network server. In step 301 one or more users request a digital document to be downloaded to the DRM device that is connected to the digital appliance. Typically following step 301, the server drives a phase of proving the eligibility of the user to receive the document. User eligibility to receive the content is determined by the server, following rules such as payment, free for use, user authentication, registration or other similar methods that may be used by a user to prove eligibility or to become eligible to receive the document. Once the server is ready to download the content, it sends the content through the network to the digital appliance that is attached to the network. The content may be encrypted or parts of it may be encrypted. According to one embodiment the DRM device must be presently attached to the digital appliance at the time of transmission. According to another embodiment the DRM device does not necessarily have to be attached at the time of transmission of the document and can be made present later when the document is to be used. At step 302 the document is transmitted from the network server (depicted as content server) to the digital appliance and from the digital appliance to the DRM device. According to one embodiment the document is completely transferred to the digital appliance before being transferred to the DRM device. According to another embodiment the document is transferred in sections, where each section is transferred to the DRM device at its own pace. On step 303 the license is transferred from the network server (depicted as license server) to the digital appliance and from the digital appliance to the DRM device. The license can be one or more files. The license contains information used by the policy, authenticator, decryptor, and/or formatter in the DRM device. According to another embodiment the license server and the content sever are implemented as a single server. According to another embodiment the license is embedded in the document to form a single file transferred from a single server. It may be appreciated by those skilled in the art that there exist other methods to sequence the transfer process with the result of having the document or part of the document and the license transferred to the DRM device. Step 304 describes the installation of the license in the non-volatile storage of the DRM device. Once installed in the DRM device, the license may activate the usage of the document according to the rights defined in the license. According to one embodiment the activation is performed immediately following the installation process. According to another embodiment the activation is performed in a later timeframe, such as at the time of usage of the document.

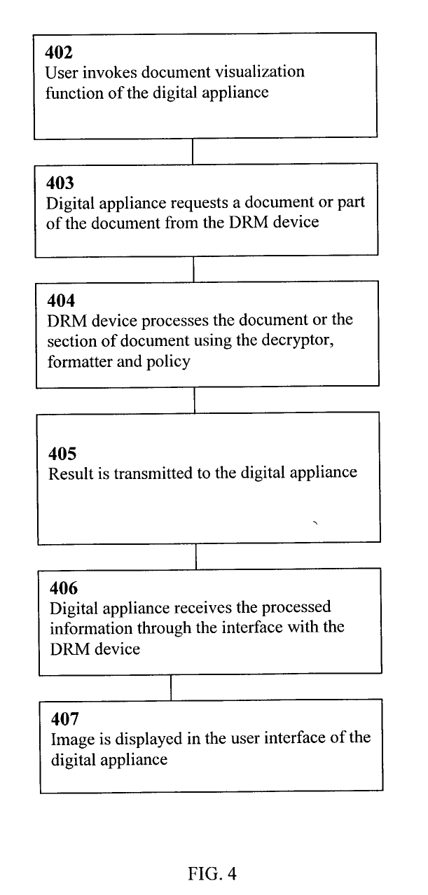

FIG. 4 is a flow chart describing an exemplary sequence of operations for using a document for visualization. In step 402 the user invokes a document usage function in the digital appliance. In step 403 the digital appliance further sends requests to the DRM device. In step 404 the DRM device processes the request by performing a sequence of operations, optionally involving one or more decryptors, one or more formatters, and one or more policies on the document or part of the document, before transferring the result to the digital appliance in step 405. According to another embodiment, part or all of the operations that involve the decryptors, formatters and/or policies is performed before the request from the digital appliance is received. The order of the operations of the decryptors, formatters and policies can be altered and executed in any sequence. The invention is not so limited.

FIG. 4 is a flow chart describing an exemplary sequence of operations for using a document for visualization. In step 402 the user invokes a document usage function in the digital appliance. In step 403 the digital appliance further sends requests to the DRM device. In step 404 the DRM device processes the request by performing a sequence of operations, optionally involving one or more decryptors, one or more formatters, and one or more policies on the document or part of the document, before transferring the result to the digital appliance in step 405. According to another embodiment, part or all of the operations that involve the decryptors, formatters and/or policies is performed before the request from the digital appliance is received. The order and existence of the operations of the decryptors, formatters and policies can be altered and can occur in any sequence. The invention is not so limited.

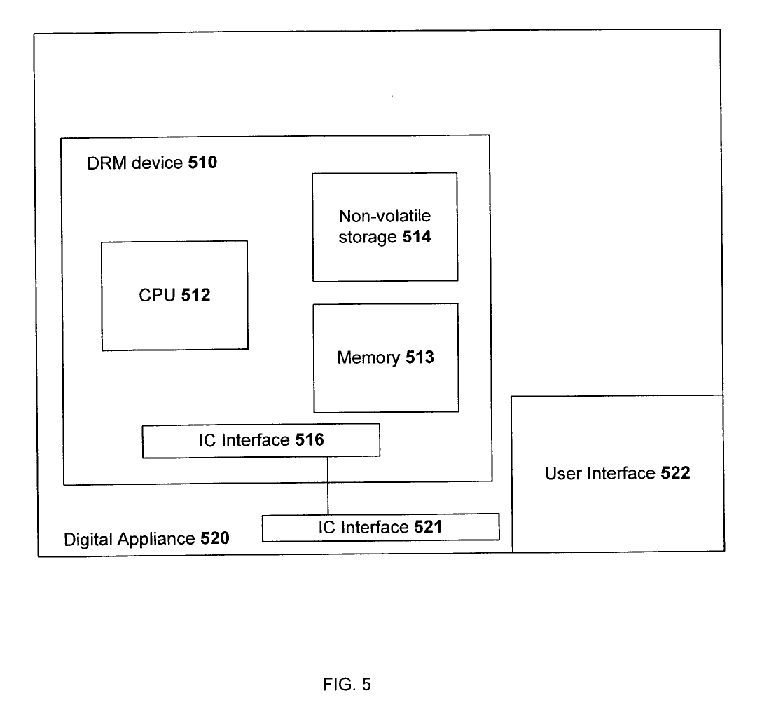

FIG. 5 is a diagram of another exemplary embodiment of the system which includes a DRM device 510 with an IC interface 516, a digital appliance 520 with an IC interface 521 which matches the IC interface 516 of the DRM device 510, and a user interface component 522 on which a processed document may be presented (for example as a visual image, synthesized audio or other form) to the user. One example of the DRM device 510 is an integrated circuit executing instructions. The DRM device 510 can be included in the digital appliance 520. In some embodiments the code or data can be stored inside the non-volatile storage of the DRM device IC, and/or can be in storage external to the DRM device IC. The DRM device IC can execute independently from a processor of the digital appliance.

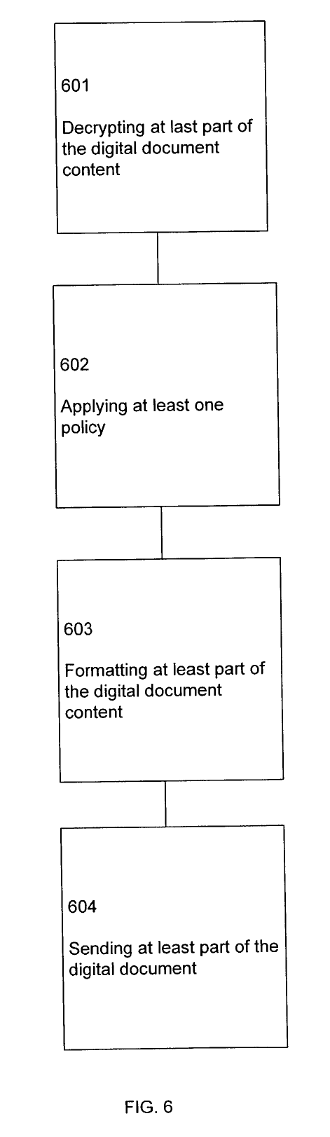

FIG. 6 is a flow chart describing another exemplary sequence of operations for using a document for visualization. In step 601, at least part of the digital document content is decrypted. In step 602, at least one policy is applied. In step 603; at least part of the digital document content is formatted. In step 604, at least part of the digital document is sent. The order and existence of the operations can be altered and can occur in any sequence.

1. A digital rights management (DRM) device for digital content management, the DRM device adapted to be coupled to a digital appliance for end use of at least part of a digital document, the DRM device comprising:
one or more nonvolatile storages adapted to store:
1) one or more authenticators;
2) one or more decryptors, wherein at least one of the decryptors is adapted to at least partly decrypt at least part of the digital document;
3) one or more policies, wherein at least one of the policies at least partly controls access to at least part of the digital document; and
4) one or more formatters, wherein at least one of the formatters at least partly arranges a presentation of at least part of the digital document; and
one or more interfaces coupled to at least one of the nonvolatile storages, the one or more interfaces for receiving and sending at least part of the digital document,
wherein at least part of the sent digital document is sent to the digital appliance for end use of the digital document.

2. The device of claim 1, wherein the DRM device is coupled to the digital appliance.

3. The device of claim 2, wherein the digital appliance is a computer.

4. The device of claim 2, wherein the digital appliance is a personal digital assistant.

5. The device of claim 2, wherein the digital appliance is a mobile phone.

6. The device of claim 1, wherein the digital document is an electronic book.

7. The device of claim 1, wherein the digital document is a corporate document

8. The device of claim 1, wherein the digital document is an academic document.

9. The device of claim 1, wherein the digital document is a commercial document.

10. The device of claim 1, wherein the DRM device, prior to a first attempted end use of the DRM device, has stored in the nonvolatile storage at least one of: at least one of the one or more authenticators, at least one of the one or more decryptors, at least one of the one or more policies, and at least one of the one or more formatters.

11. The device of claim 1, wherein the DRM device, at least partly responsive to a first attempted use of the DRM device, downloads into the nonvolatile storage at least one of: at least one of the one or more authenticators, at least one of the one or more decryptors, at least one of the one or more policies, and at least one of the one or more formatters.

12. The device of claim 1, wherein the DRM device couples to the digital appliance via a physical connection to the digital appliance.

13. The device of claim 12, wherein the physical connection includes one or more cables.

14. The device of claim 1, wherein the DRM device couples to the digital appliance by directly physically connecting to the digital appliance.

15. The device of claim 1, wherein the DRM device couples to the digital appliance by remotely connecting to the digital appliance.

16. The device of claim 1, wherein the DRM device couples to the digital appliance by wirelessly connecting to the digital appliance.

17. The device of claim 1, wherein at least part of the received digital document content is received encrypted.

18. The device of claim 1, wherein at least part of the received digital document content is received as plaintext.

19. The device of claim 1, wherein the presentation is at least partly visual data.

20. The device of claim 1, wherein the presentation is at least partly audio data.

21. A digital rights management (DRM) integrated circuit (IC) for digital content management, the DRM IC adapted to be included in a digital appliance for end use of at least part of a digital document, the DRM IC comprising:
one or more nonvolatile storages adapted to execute:
1) one or more authenticators;
2) one or more decryptors, wherein at least one of the decryptors is adapted to at least partly decrypt at least part of the digital document;
3) one or more policies, wherein at least one of the policies at least partly controls access to at least part of the digital document; and
4) one or more formatters, wherein at least one of the formatters at least partly arranges a presentation of at least part of the digital document; and
one or more interfaces coupled to at least one of the nonvolatile storages, the one or more interfaces for receiving and sending at least part of the digital document,
wherein at least part of the sent digital document is sent to a processor in the digital appliance for end use of the digital document.

22. A digital rights management (DRM) system for digital content management, the DRM system including:
one or more servers, wherein the one or more servers send at least one of: authentication data, decryption data, policy data, formatting data, and at least part of digital document content data;
a digital appliance for end use of at least part of the digital document content; and
a DRM device adapted to be coupled to the digital appliance, the DRM device comprising:
one or more nonvolatile storages adapted to store:
1) one or more authenticators;
2) one or more decryptors, wherein at least one of the decryptors is adapted to at least partly decrypt at least part of the digital document content;
3) one or more policies, wherein at least one of the policies at least partly controls access to at least part of the digital document content; and
4) one or more formatters, wherein at least one of the formatters at least partly arranges a presentation of at least part of the digital document content; and
one or more interfaces coupled to at least one of the nonvolatile storages, the one or more interfaces for receiving at least data from the one or more servers and sending at least part of the digital document content to at least the digital appliance,
wherein at least part of the sent digital document content is sent to the digital appliance for end use of at least part of the digital document content.

23. A method of digital rights management (DRM) with a DRM device for at least part of the digital document content, comprising:
applying at least one policy to at least part of the digital document content in the DRM device;
formatting at least part of the digital document content in the DRM device; and
sending at least part of the digital document for end use to a digital appliance coupled to the DRM device.

24. The device of claim 23, further comprising:
decrypting at least part of the digital document content in the DRM device.
